(19) United States
(12) Patent Application Publication
(10) Pub. No.: US 2026/0266366 A1
(43) Pub. Date: Sep. 10, 2026

(54) IMPROVED FILTERING PULLEY

(71) Applicant: MUVIQ S.R.L., Ivrea (IT)

(72) Inventors: Andrea GUALA, Ivrea (IT); Jacopo SPINELLI, Ivrea (IT); Stefano AMADIO, Ivrea (IT)

(73) Assignee: MUVIQ S.R.L., Ivrea, TO (IT)

(21) Appl. No.: 19/167,446

(22) PCT Filed: Mar. 22, 2024
(86) PCT No.: PCT/IB2024/052752

§ 371 Date: Sep. 22, 2025

(30) Foreign Application Priority Data
Mar. 23, 2023 (IT) 102023000005571

(51) Int. Cl. F16H 55/36; F16D 3/12; F16D 3/66

(52) U.S. Cl. CPC F16H 55/36; F16D 3/12; F16D 3/66; F16H 2055/366

(57) ABSTRACT

A filtering pulley has a hub adapted to be fixed to a shaft, a crown mounted coaxially and rotationally free on the hub, at least one elastic group arranged circumferentially with respect to hub and to the crown, each interposed between a pair of first elements integral with the hub and between a pair of second elements integral with the crown. The pulley has a dust seal system defining an inner radial surface having a profile with a designed shape which is optimized to prevent the leakage of oil with respect to a space housing said elastic group.

### CROSS-REFERENCE TO RELATED APPLICATIONS

This Patent Application claims priority from Italian Patent Application No. 102023000005571 filed on Mar. 23, 2023, the entire disclosure of which is incorporated herein by reference.

### TECHNICAL FIELD

This invention relates to a filtering pulley, preferably a pulley for a crankshaft in an accessory transmission of an internal combustion engine.

### STATE OF THE PRIOR ART

As is well known, the drive shaft in internal combustion engines is subject to torsional vibrations due to periodic stresses caused by combustion in the cylinders. These vibrations are particularly intense at start-up and at low engine speeds, as well as in the presence of particular construction solutions such as, for example, the use of dual-clutch gearboxes or start-stop systems.

Torsional vibrations result in unevenness in the rotation of the drive pulley of the accessory transmission, which is transmitted to the accessories via the transmission belt, which is therefore subject to periodic tension variations.

In order to “filter” the torsional oscillations transmitted from the crankshaft to the belt, a filtering pulley provided with a hub integral with the drive shaft is generally used as the drive pulley, as well as a crown cooperating with the belt, and one or more elastic elements through which the drive torque is transmitted from the hub to the crown.

These filtering pulleys require lubricating fluid configured to lubricate the one or more elastic elements that move within the filtering pulley under the action of an actuator element, as illustrated in WO2020173515 A1, for example.

This configuration provides a friction ring having an inner circumferential surface with a conicity such as to direct the oil towards the one or more elastic elements due to the action of the centrifugal force.

However, due to the very shape of this inner circumferential surface, the lubricating fluid tends not to discharge effectively towards the filtering elements, especially during acceleration and deceleration of the filtering pulley.

The object of this invention is to provide a filtering pulley that solves the above-mentioned technical problem in a simple and economical way.

### SUMMARY OF THE INVENTION

The above object is achieved by means of a filtering pulley as claimed by the attached claims.

### BRIEF DESCRIPTION OF THE DRAWINGS

In order to better understand this invention, a preferred embodiment thereof will now be described by way of non-limiting example and with reference to the accompanying drawings, in which:

FIG. 1 is an exploded, perspective view of a filtering pulley according to the invention along its rotation axis;

FIG. 2 is an axial sectional view along the rotation axis of the pulley in FIG. 1;

FIG. 3 is an enlarged sectional view of FIG. 2; and

FIG. 4 is an enlarged view of the portion IV in FIG. 3.

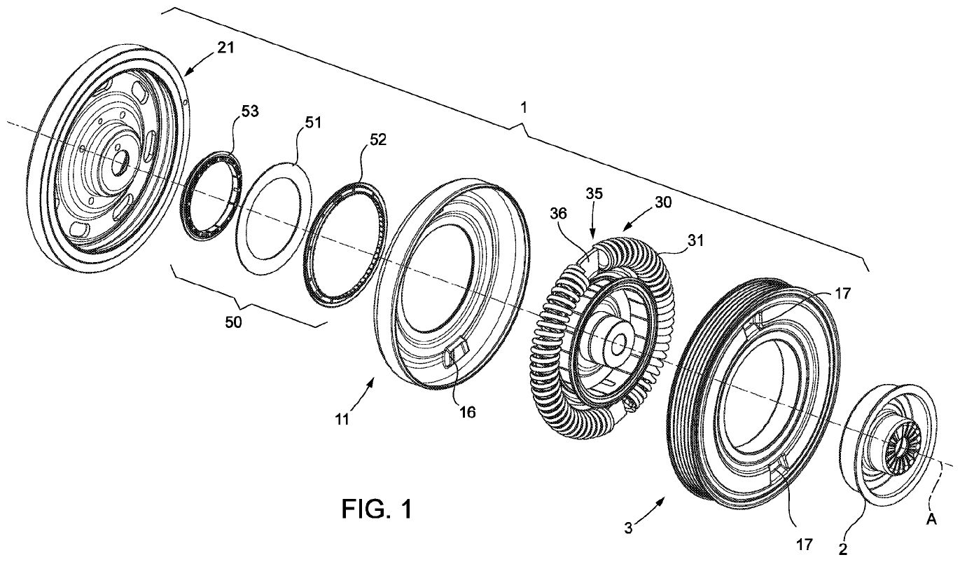

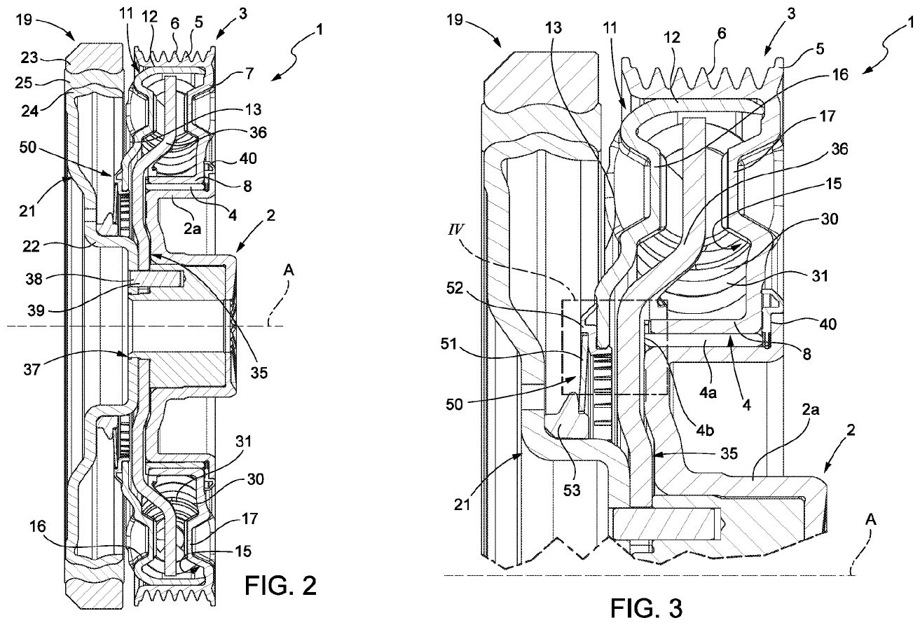

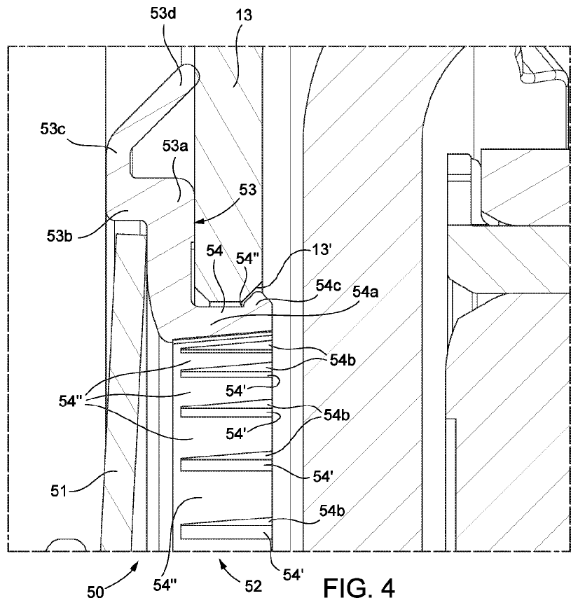

### DETAILED DESCRIPTION OF THE INVENTION

The attached figures show a filtering pulley 1 comprising a hub 2 with an axis A, adapted to be connected to a shaft (not shown), for example a crankshaft of an internal combustion engine, and an annular crown 3 externally coaxial with the hub 2 and supported in a rotationally free way on the hub 2 by a support element 4.

The crown 3 comprises an annular portion 5 provided with a profile 6 designed to cooperate with a poly-V belt (not shown). The crown 3 also comprises a radial wall 7, integral with the annular portion 5 and preferably of one piece with it, extending radially towards the hub 2, and a basically cylindrical inner wall 8 of axis A.

The crown 3 carries, integral therewith, a closure element 11 comprising an outer cylindrical wall 12 of axis A and a radial annular wall 13, which advantageously is of a designed shape. In the described embodiment, the closure element 11 is planted in the crown 3 so as to form an annular chamber 15 radially comprised between the wall 12 and the wall 8 and axially bounded by the wall 7 and the wall 13.

Lastly, the closure element 11 comprises two diametrically opposite projections 16 extending axially within the chamber 15 from the wall 13 (see FIG. 3). The projections 16 divide the chamber 15 into two portions preferably equal in size.

Two additional projections 17, preferably arranged facing the aforementioned projections 16, are provided on the wall 7. The projections 16 and 17 are fixedly carried by the respective walls or, alternatively, made in one piece therewith.

The pulley 1 can also be provided with a dynamic damper 19 comprising a disc 21, facing the closure element 11 and having a portion of the hub 22 integral with the hub 2, and a seismic ring 23 constrained to a peripheral flange 24 of the disc 21 by a ring 25 of elastomeric material.

As shown, the pulley 1 further comprises at least one elastic group 30, for example two arched elastic groups 30 arranged circumferentially free in the respective portions of the chamber 15 bounded by the projections 16, 17.

Each of the elastic groups 18 comprises at least one spring, in this case a helical and arched spring 31 mounted between the above-mentioned projections 16.

The pulley 1 also comprises an actuator 35 integrally carried by the hub 2 and advantageously axially interposed between the hub 2 and the disc 21 of the dynamic damper 19. The actuator 35 has two spokes 36 that are free to move circumferentially in the chamber 15 and are designed to interact with the elastic groups 30 by contact, as described below.

Advantageously, the actuator 35 is carried by the hub 2 by means of a form coupling 37, for example by means of a plurality of pins 39 configured to be inserted into an opening 39 made on the actuator 35 and the hub 2. Preferably, the form coupling 37 also allows the disc 21 of the dynamic damper 19 to be coupled to the hub 2, whereby the latter includes openings suitable for the insertion of the pins 38.

The actuator 35 may be placed in contact with the elastic groups 30, possibly with a circumferential interference value such as to preload these elastic groups 30 within the seat 15. Alternatively, it can be placed with an angular interval with respect to the elastic groups 30, that is, an angular clearance before it comes into contact with them.

The pulley 1 also includes a dust seal lip 40 configured to prevent contamination of the rotating support 4 between the hub 2 and the crown 3 from the outside.

According to a further aspect of the invention, the rotating support 4 is a bushing with an “L” section provided with an annular cylindrical portion 4a and a radial wall 4b made of one piece.

The cylindrical portion 4a is radially interposed in contact between the hub 2 and the wall 8 and configured to support a radial load between the crown 3 and the hub 2, whereas the radial wall 4b is placed axially in contact with the wall 8 and faces the actuator 35, i. e., opposite the dust seal lip 40, without contact with it. The radial wall 4b is therefore designed to contain any axial loads acting on the crown 3.

The dust seal lip 40 is axially interposed between a flange 2a of the hub 2 and the wall 7, connecting the walls 8 and 5, advantageously in a radially external position in relation to the bushing 4. In greater detail, the dust seal lip 50 is placed in contact between the wall 7 and the flange 2a.

Advantageously, the flange 2a is made separate from and can be attached to a main body of the hub 2.

The pulley 1 may also comprise a dust seal system 50 configured to insulate the space 15 from the outside and extending between the wall 13 of the element 11 and the hub 2 and, optionally, at the same time to generate an axial force, i.e., along the axis A on the wall 13, designed to generate damping between the hub 2 and the pulley 3.

In particular, the dust seal system 50 comprises a sealing element 52 configured to be placed in contact with the wall 13 and, optionally, an elastic element 51 configured to give an axial compression force along the axis A, as in the case illustrated.

In greater detail, the wall 13, as mentioned, extends towards the hub 2 without contact with it and therefore defines an inner annular edge 13a on which the sealing element 52 cooperates.

In particular, the elastic element 51 may comprise a leaf spring, advantageously of the conical disc or Belleville type, integrally carried by the actuator 35, or a diaphragm spring clamped on it.

Hence, the spring defines an inner end and an outer end, where the outer end is the one that cooperates with the sealing element 52 to provide it with the compressive force along the axis A.

The inner end is rigidly carried by a support ring 53 and, in the case described, is advantageously fitted to the dynamic damper 19, in particular to the disc 21.

Advantageously, the sealing element 52 comprises a radial portion 53 and an axial portion 54. In particular, the axial portion 54 is radially in contact with the inner annular edge 13a, whereas the radial portion 53 is axially in contact with the end portion of the wall 13 and cooperates in contact with the elastic element 51.

Therefore, advantageously, the elastic element 51 and the sealing element 52 are made as separate elements. Preferably, the sealing element 52 is made of polymeric or plastic material.

Advantageously, the axial portion 54 comprises an inner radial surface 54′, that is, opposite to an outer radial surface 54″ configured to cooperate in contact with the shaped edge 13a, and an intermediate radial surface 54′″ radially comprised between the outer radial surface 54″ and the inner radial surface 54′.

The outer radial surface 54″ is substantially flat, whereas the intermediate radial portion 54′″ is shaped so that the thickness of the axial portion 54 decreases as it moves away from the elastic element 51, i.e., as it approaches the space 15.

Hence, a portion of the axial portion 54, radially bounded by the inner radial surface 54′ and the outer radial surface 54″, is of constant thickness along the axis A, whereas a portion of the axial portion 54, radially bounded by the intermediate radial surface 54′″ and the outer radial surface 54″, is of varying thickness, in particular, with a maximum value at the radial portion 53 and a minimum value near the chamber 15. Advantageously, the intermediate radial surface 54′″ is conical.

Preferably, the intermediate radial surface 54′″ is circumferentially discontinuous along the axis A, in other words, sections of the outer radial surface 54″ are circumferentially alternated with sections of the intermediate radial surface 54′″.

In particular, the sections of the outer radial surface 54″ have the same circumferential extension, just as the sections of the intermediate radial surface 54′″ have the same circumferential extension.

According to the above, the sections of the outer radial surface 54″ are obtained on ribs 5ab, which extend radially from a main body 54a of the axial portion 54 defining the intermediate radial surface 54′″ and can be spaced and dimensioned for this purpose and advantageously circumferentially equispaced, as described above.

Preferably, the axial portion 54 further comprises an appendage portion 54c extending radially opposite the above ribs 54b from the inner radial surface 54′ and configured to cooperate in contact with the wall 13 on the side opposite the radial portion 53.

The radial portion 53 is conveniently shaped and, in the preferred embodiment described herein, comprises an inner radial section 53a connected to the axial portion 54, an axial section 53b extending opposite the axial portion 54 towards the external environment, an outer radial section 53c parallel to the inner radial section 53a, and an inclined section 53d extending so that one of its end portions cooperates in contact with the wall 13.

In this configuration, the elastic element 51 cooperates in contact with the inner radial section 53a. In particular, the shaping of the radial portion 13 can be considered a labyrinthine portion.

The operation of the pulley 1 is described below.

In a first phase of operation, called “driving mode” and constituting the normal operation of the pulley 1, when the drive shaft drags the accessories, the speed of the hub 2 tends to exceed the speed of the crown 3. For this reason, the spokes 36 of the actuator 35 transmit torque to the projections 16 with the interposition of the respective elastic groups 30.

The above occurs symmetrically in the “overrunning” condition, i.e., when the speed of the crown 3 tends to exceed the speed of the hub 2.

Depending on the damping between the hub 2 and the crown 3, as known per se, a hysteresis may be present in relation to the two operations described above. In the event of major angular variations that could damage the elastic groups 30, the projections 17 prevent excessive relative rotation between the hub 2 and the crown 3.

The actuator 35, whether in preloaded contact or spaced from the elastic groups, allows or does not allow an angular clearance between the hub 2 and the crown 3.

During the movement between the hub 2 and the crown 3, the dust seal system 50 is dragged in its rotation around the axis A. During this sliding, it performs the function of preventing dirt from reaching the space 15 and provides a force to the cover 11 along the axis A, which generates damping to the rotation between the hub 2 and the crown 3.

Furthermore, during the rotation of the hub 2, due to the presence of the circumferential discontinuity between the outer 54″ and the intermediate 54′″ radial portions, it favours the flow of the oil towards the space 15.

In particular, the presence of the above-mentioned ribs 54b prevents the oil from leaking to the external environment during acceleration variations as it is channelled towards the chamber 15.

The advantages of a pulley 1 according to the invention thus become apparent.

The dust seal system 50 makes it possible to prevent the lubricating oil from leaking out of the space 15 during acceleration variations of the hub 2/crown 3.

In fact, the special shape of the inner radial surface 54′ prevents the oil from leaking to the external environment even during acceleration variations which hinder an adequate centripetal acceleration that would push the lubricating oil towards the space 15.

Lastly, it is clear that modifications and variations may be made to the pulley described herein without departing from the scope of protection defined by the claims.

First of all, the pulley could be used not only on the crankshaft of an internal combustion engine but for one of its accessories.

With reference to the elastic group 30, it may be made without however changing its function. For example, it may include springs of different nature or multiple springs, either in series or in parallel. Furthermore, the elastic groups could be four, like the spokes of the actuator.

The dynamic damper may be missing and the actuator may be carried differently by the hub 2.

Furthermore, the shape of the sealing element 52 of the dust seal system 50 could vary according to the limits stated in the claims.

As reported, the elastic element 51 may also be missing and only the sealing element 52 may be present.

1. A filtering pulley comprising:
a hub adapted to be fixed to a shaft rotating around an axis (A),
a crown mounted coaxially and rotationally free on said hub,
at least one group elastic arranged circumferentially with respect to said hub and to said crown, each interposed between a pair of first elements integral with said hub and between a pair of second elements integral with said crown,
a dust seal system integrally carried by said hub and configured to slide, hermetically, with respect to an element integral with said crown, said dust seal system being configured to insulate said at least one elastic group with respect to the external environment,
a sealing element comprising an axial portion provided with an outer radial surface cooperating in contact with said element integral with said crown, a flat inner radial surface and an intermediate radial surface radially included between said outer radial surface and said inner radial surface inclined with respect to said axis (A).

2. The pulley according to claim 1, wherein said intermediate radial surface is circumferentially discontinuous.

3. The pulley according to claim 1, wherein said intermediate radial surface and inner radial surface are circumferentially alternated with each other.

4. The pulley according to claim 3, wherein the sections of intermediate radial surface extend circumferentially equally to each other.

5. The pulley according to claim 3, wherein the sections of inner radial surface extend circumferentially equally to each other.

6. The pulley according to claim 1, wherein said inner radial surface is defined on ribs extending radially from said intermediate radial surface.

7. The pulley according to claim 1, comprising an appendage portion extending radially from said outer radial surface on the opposite side of said inner radial surface to cooperate in contact with said element integral with said crown.

8. The pulley according to claim 1, wherein said sealing element is made of polymeric or plastic material.

9. The pulley according to claim 1, wherein said sealing element comprises a radial portion extending radially from said axial portion.

10. The pulley according to claim 9, wherein said axial portion is shaped.

11. The pulley according to claim 9, wherein said axial portion is labyrinth-shaped.

12. The pulley according to claim 1, wherein said dust seal system is further configured to provide an axial force generating damping to the movement between said hub and said crown and comprises an elastic element provided with a first end connected to the hub and a second end cooperating with said sealing element.

13. The pulley according to claim 12, wherein said elastic element is a Belleville washer.

14. The pulley according to claim 12, wherein said sealing element is made separate from said elastic element and cooperates in contact with it.

15. The pulley according to claim 1, wherein said first elements comprise at least two spokes carried by an actuator integral with the hub, said dust seal system being carried by said hub.

16. The pulley according to claim 10, wherein said actuator is carried by said hub by means of a form coupling.

17. The pulley according claim 1, wherein said second elements are projections integral with an element of said crown.

18. The pulley according to claim 17, wherein said at least one elastic group can slide circumferentially inside a seat formed between said first elements and/or said second elements.

19. The pulley according to claim 1 characterized in that it comprises a dynamic damper.
